(19) United States
(12) Patent Application Publication
(10) Pub. No.: US 2018/0030916 A1
(43) Pub. Date: Feb. 1, 2018

(54) SYSTEM FOR CONTROLLING FUEL RAIL PRESSURE IN A COMMON RAIL DIRECT FUEL INJECTION SYSTEM

(71) Applicant: EcoMotors, Inc., Allen Park, MI (US)

(72) Inventors: Ali Nabi, Belmont, CA (US); Qi Luo, San Jose, CA (US); Robert Merrion, Pittsboro, IN (US); John Kresse, Martinsville, IN (US); Hosein Mahjoubi, Westland, MI (US)

(73) Assignee: EcoMotors, Inc.

(21) Appl. No.: 15/224,201

(22) Filed: Jul. 29, 2016

(51) Int. Cl. F02D 41/26; F02D 41/00; F02M 63/02

(52) U.S. Cl. CPC F02D 41/263; F02M 63/0265; F02M 63/025; F02D 41/0025; F02M 2200/247; F02M 2200/248

(57) ABSTRACT

A system and method are provided for controlling fuel rail pressure in a common rail fuel injection system. A desired rail pressure value is determined based on signals produced by one or more sensors, a feedback PCV control signal is determined based on a difference between the desired rail pressure value and a fuel rail pressure signal, a feedforward PCV signal is determined based on the desired rail pressure value, and a PCV control signal for controlling a pressure control valve fluidly coupled to the fuel rail is determined based on the feedback PCV control signal and the feedforward PCV control signal. The pressure control valve signal is correlated with the temperature of fuel exiting the pressure control valve such that operation of the pressure control valve in response to the PCV control signal results in a valve outlet orifice size which controls the temperature exiting fuel.

### FIELD OF THE INVENTION

The present invention relates generally to systems and methods for controlling fuel injection systems, and more specifically to systems and methods for controlling fuel rail pressure in a common rail fuel injection system.

### BACKGROUND

The efficiency of internal combustion (IC) engines typically relies on the combustion quality in the engine cylinders, and this is true both in spark-ignited engines and compression ignition engines. Generally, common rail fuel injection systems and direct injection of fuel into the cylinders have improved the efficiency of the IC engines, although one ongoing challenge in such fuel injection systems is achieving and maintaining accurate control of the fuel rail pressure.

It is desirable to reduce the pumping losses in any high pressure fuel system, and particularly in high pressure common rail fuel systems for compression ignition engines, as excessive pressurized fuel and excessive amounts of fuel bypassing the fuel rail undesirably consumes additional crankshaft energy, thereby increasing brake specific fuel consumption. A secondary effect of excessive bypassed fuel is unnecessary heating of the fuel which can potentially cause damage to wetted components. Therefore, in addition to achieving precise pressure control for the fuel rail, it is desirable to control fuel temperature throughout the system, both in transient and steady-state operational conditions, and particularly in the return line(s) from the fuel rail back to the fuel supply. Excessively high fuel temperatures in such return line(s) can result in vaporization of the fuel and even damage to the fuel lines.

### SUMMARY

The present invention may comprise one or more of the features recited in the attached claims, and/or one or more of the following features and combinations thereof. In one aspect a system for controlling fuel rail pressure may comprise a fuel rail, a fuel pump to supply pressurized fuel from a source of fuel to the fuel rail, a pressure sensor to produce a rail pressure signal corresponding to fuel pressure within the fuel rail, a plurality of additional sensors each producing a signal corresponding to a different operating parameter of an internal combustion engine to which the fuel rail and the fuel pump are operatively coupled, a pressure control valve having a fuel inlet fluidly coupled to the fuel rail, a fuel outlet and a control input responsive to a PCV control signal to establish a corresponding orifice size at the fuel outlet thereof, a processor, and a memory having instructions stored therein which, when executed by the processor, cause the processor to determine a desired rail pressure value based on signals produced by one or more of the plurality of additional sensors, to determine a feedback PCV control signal based on a difference between the desired rail pressure value and the rail pressure signal, to determine a feedforward PCV control signal based on the desired rail pressure, and to produce the PCV control signal based on a sum of the feedback PCV control signal and the feedforward PCV control signal. The feedforward PCV control signal is illustratively correlated with temperature of fuel exiting the fuel outlet of the pressure control valve such that operation of the pressure control valve in response to the PCV control signal results in fuel outlet orifice sizes which one of maintains the temperature of fuel exiting the fuel outlet of the pressure control valve within a specified temperature range and limits the temperature of fuel exiting the fuel outlet to a specified maximum temperature.

In another aspect, a system for controlling fuel rail pressure may comprise a fuel rail, a fuel pump to supply pressurized fuel from a source of fuel to the fuel rail, a pressure sensor to produce a rail pressure signal corresponding to fuel pressure within the fuel rail, a plurality of additional sensors each producing a signal corresponding to a different operating parameter of an internal combustion engine to which the fuel rail and the fuel pump are operatively coupled, a pressure control valve having a fuel inlet fluidly coupled to the fuel rail, a fuel outlet and a control input responsive to a PCV control signal to establish a corresponding orifice size at the fuel outlet thereof, at least a first logic module to determine a desired rail pressure value based on signals produced by one or more of the plurality of additional sensors, a first feedback controller to determine a feedback PCV control signal based on a difference between the desired rail pressure value and the rail pressure signal, a first feedforward module including a map populated with feedforward PCV control values mapped to corresponding desired rail pressure values, the first feedforward module to determine a feedforward PCV signal by mapping desired rail pressure values to corresponding feedforward PCV control values using the map, and at least a second logic module to produce the PCV control signal based on a sum of the feedback PCV control signal and the feedforward PCV control signal. The feedforward control values populating the map are illustratively correlated with temperature of fuel exiting the fuel outlet of the pressure control valve such that operation of the pressure control valve in response to the PCV control signal results in fuel outlet orifice sizes which one of maintains the temperature of fuel exiting the fuel outlet of the pressure control valve within a specified temperature range and limits the temperature of fuel exiting the fuel outlet to a specified maximum temperature

In a further aspect, a method is provided for controlling fuel rail pressure in a common rail fuel injection system having a common rail, a fuel pump to supply pressurized fuel from a fuel source to the fuel rail, a pressure sensor to produce a rail pressure signal corresponding to fuel pressure within the fuel rail, a plurality of additional sensors each producing a signal corresponding to a different operating parameter of an internal combustion engine to which the fuel rail and the fuel pump are operatively coupled and a pressure control valve having a fuel inlet fluidly coupled to the fuel rail, a fuel outlet and a control input responsive to a PCV control signal to establish a corresponding orifice size at the fuel outlet thereof. The method may comprise determining, with a processor, a desired rail pressure value based on signals produced by one or more of the plurality of additional sensors, determining, with the processor, a feedback PCV control signal based on a difference between the desired rail pressure value and the rail pressure signal produced by the pressure sensor, populating a map stored in a memory with pressure control valve control values mapped to corresponding desired rail pressure values, the pressure control valve control values correlated with values of temperature of fuel exiting the fuel outlet of the pressure control valve such that operation of the pressure control valve in response to a combination of the feedback PCV control signal and any of the pressure control valve control values results in a fuel outlet orifice size which one of maintains the temperature of fuel exiting the fuel outlet of the pressure control valve within a specified temperature range and limits the temperature of fuel exiting the fuel outlet to a specified maximum temperature, determining, with the processor, a feedforward PCV signal by mapping the desired rail pressure value to a corresponding one of the pressure control valve control values populating the map, producing, with the processor, the PCV control signal based on a sum of the feedback PCV control signal and the feedforward PCV control signal, and controlling the pressure control valve by applying, via the processor, the PCV control signal to the control input of the pressure control valve.

In yet a further aspect, a system for controlling fuel rail pressure may comprise a fuel rail, a fuel pump to supply pressurized fuel from a source of fuel to the fuel rail, a pressure sensor to produce a rail pressure signal corresponding to fuel pressure within the fuel rail, a plurality of additional sensors each producing a signal corresponding to a different operating parameter of an internal combustion engine to which the fuel rail and the fuel pump are operatively coupled, a pressure control valve having a fuel inlet fluidly coupled to the fuel rail, a fuel outlet and a control input responsive to a PCV control signal to establish a corresponding orifice size at the fuel outlet thereof, a volume control valve having a fuel inlet to receive fuel from the source of fuel, a fuel outlet fluidly coupled to a fuel inlet of the fuel pump and a control input responsive to a VCV control signal to establish a corresponding orifice size at the fuel outlet thereof, a processor, and a memory having instructions stored therein which, when executed by the processor, cause the processor to determine a desired rail pressure value based on signals produced by one or more of the plurality of additional sensors, to determine a feedback PCV control signal based on a difference between the desired rail pressure value and the rail pressure signal, to determine a feedforward PCV control signal based on the desired rail pressure, to produce the PCV control signal based on a sum of the feedback PCV control signal and the feedforward PCV control signal, to determine a desired pressure control valve control value and an injected fuel quantity based on signals produced by one or more of the plurality of additional sensors, to determine a feedforward VCV control signal based on the injected fuel quantity, to determine a feedback VCV control signal based on a difference between the desired pressure control valve control value and the PCV control signal and to produce the VCV control signal based on a sum of the feedforward VCV control signal and the feedback VCV control signal.

In still a further aspect, a method is provided for controlling fuel rail pressure in a common rail fuel injection system having a common rail, a fuel pump to supply pressurized fuel from a fuel source to the fuel rail, a pressure sensor to produce a rail pressure signal corresponding to fuel pressure within the fuel rail, a plurality of additional sensors each producing a signal corresponding to a different operating parameter of an internal combustion engine to which the fuel rail and the fuel pump are operatively coupled, a pressure control valve having a fuel inlet fluidly coupled to the fuel rail, a fuel outlet and a control input responsive to a PCV control signal to establish a corresponding orifice size at the fuel outlet thereof and a volume control valve having a fuel inlet to receive fuel from the source of fuel, a fuel outlet fluidly coupled to a fuel inlet of the fuel pump and a control input responsive to a VCV control signal to establish a corresponding orifice size at the fuel outlet thereof. The method may comprise determining, with a processor, a desired rail pressure value based on signals produced by one or more of the plurality of additional sensors, determining, with the processor, a feedback PCV control signal based on a difference between the desired rail pressure value and the rail pressure signal produced by the pressure sensor, determining, with the processor, a feedforward PCV signal based on the desired rail pressure value, producing, with the processor, the PCV control signal based on a sum of the feedback PCV control signal and the feedforward PCV control signal, controlling the pressure control valve by applying, via the processor, the PCV control signal to the control input of the pressure control valve, determining, with the processor, a desired pressure control valve control value based on signals produced by one or more of the plurality of additional sensors, determining, with the processor, a feedback PCV control signal based on a difference between the desired pressure control valve control value and the PCV control signal, determining, with the processor, a feedforward VCV signal based on an injected fuel quantity value determined based on signals produced by one or more of the plurality of sensors, and producing, with the processor, the VCV control signal based on a sum of the feedback CCV control signal and the feedforward CCV control signal, and controlling the volume control valve by applying, via the processor, the VCV control signal to the control input of the volume control valve.

### BRIEF DESCRIPTION OF THE DRAWINGS

This disclosure is illustrated by way of example and not by way of limitation in the accompanying Figures. Where considered appropriate, reference labels have been repeated among the Figures to indicate corresponding or analogous elements.

FIG. 1 is a simplified diagram of an embodiment of a control system for controlling fuel rail pressure in a common rail fuel injection system.

FIG. 2 is a simplified diagram of an embodiment of a control structure for controlling fuel rail pressure in a common rail fuel injection system.

FIG. 3 is a simplified flowchart illustrating an embodiment of a process for controlling fuel rail pressure in a common rail fuel injection system.

### DETAILED DESCRIPTION OF THE DRAWINGS

While the concepts of the present disclosure are susceptible to various modifications and alternative forms, specific exemplary embodiments thereof have been shown by way of example in the drawing and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure or characteristic is described in connection with an embodiment, it is submitted that it is within the knowledge of one skilled in the art to effect such feature, structure or characteristic in connection with other embodiments whether or not explicitly described. Further still, it is contemplated that any single feature, structure or characteristic disclosed herein may be combined with any one or more other disclosed feature, structure or characteristic, whether or not explicitly described, and that no limitations on the types and/or number of such combinations should therefore be inferred.

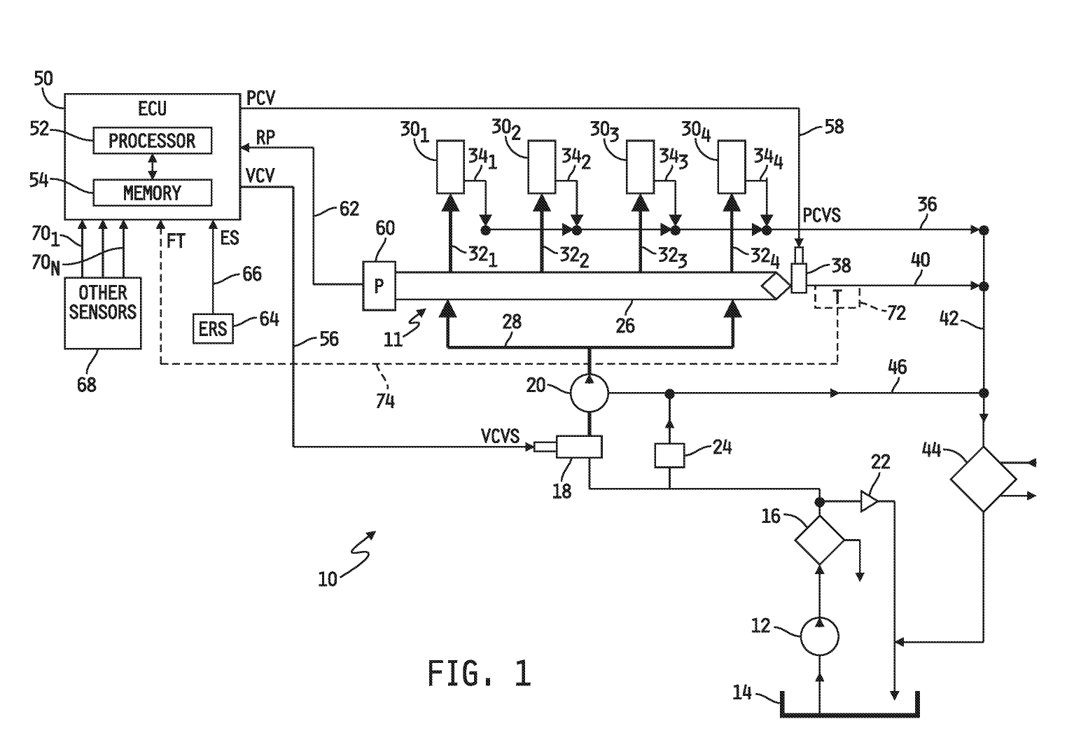

Referring to FIG. 1, an embodiment is shown of a control system 10 for controlling fuel rail pressure in a common rail fuel injection system 11. In the illustrated embodiment, the common rail fuel injection system 11 includes a conventional low pressure fuel pump 12 having a fuel inlet fluidly coupled to a source 14 of fuel, e.g., a fuel tank or fuel reservoir, and a fuel outlet fluidly coupled to a fuel inlet of a volume control valve (VCV) 18. In some embodiments, such as that illustrated in FIG. 1, a conventional fuel filter 16 may be disposed in-line between the fuel outlet of the fuel pump 12 and the fuel inlet of the valve 18, and a fuel outlet of the valve 18 is fluidly coupled to a fuel inlet of a high pressure pump 20. In other embodiments, the fuel filter 16 may be disposed in an alternate location between the pumps 12, 20 or be omitted altogether.

In the illustrated embodiment, fluid inlets of a conventional air bleed valve 22 and of a conventional (mechanical) pressure relief valve 24 are fluidly coupled to the junction defined between the fuel outlet of the fuel filter 16 and the fuel inlet of the valve 18. A fluid outlet of the air bleed valve 22 opens to the fuel supply 14, and a fluid outlet of the pressure relief valve 24 is fluidly coupled to a fuel return outlet of the high pressure fuel pump 20. The air bleed valve 22 illustratively operates in a conventional manner to release trapped, pressurized air back to the fuel supply 12, and the pressure relief valve 24 illustratively operates in a conventional manner to release pressurized fuel to the air bleed outlet of the high pressure fuel pump 20 under conditions in which the pressure at the junction defined between the fuel outlet of the fuel filter 16 and the fuel inlet of the valve 18 reaches a threshold pressure.

The fuel outlet of the high pressure fuel pump 20 is fluidly coupled to one or more fuel inlets of a conventional high pressure fuel rail 26 via one or more corresponding high pressure fuel lines 28, and one or more fuel outlets of the fuel rail 26 are fluidly coupled to fuel inlets of one or more corresponding fuel injectors. In the example embodiment shown in FIG. 1, the common rail fuel injection system 11 illustratively includes four conventional fuel injectors 30₁-30₄, each having a fuel inlet fluidly coupled to a corresponding fuel outlet of the fuel rail 26 via a corresponding, dedicated high pressure fuel line 32₁-32₄. It will be understood, however, that in alternate embodiments the common rail fuel injection system may include more or fewer such fuel injectors. In any case, a fuel outlet of each fuel injector 30₁-30₄ is fluidly coupled to one or more cylinders of an internal combustion engine (not shown), and the fuel injectors 30₁-30₄ are illustratively controlled in a conventional manner to inject fuel into the one or more cylinders via the fuel outlets thereof.

Each of the fuel injectors further includes a fuel return outlet, and in the embodiment illustrated in FIG. 1 the fuel return outlet of each of the fuel injectors 30₁-30₄ is fluidly coupled to a corresponding, dedicated fuel return line 34₁-34₄, the fuel outlets of which are all fluidly coupled to a common injector fuel return line 36. A pressure control valve (PCV) 38 has a fuel inlet fluidly coupled to an outlet of the fuel rail 26, and a fuel outlet fluidly coupled to a rail fuel return line 40. The injector fuel return line 36 and the rail fuel return line 40 are both fluidly coupled to a common fuel return line that is, in the illustrated example, fluidly coupled to a fuel inlet of a conventional heat exchanger 44 and also to a return line 46 that is fluidly coupled to the fuel return outlet of the high pressure fuel pump 20 and the fuel outlet of the pressure relief valve 24. A fuel outlet of the heat exchanger 44 opens to the fuel supply 14. In embodiments that include it, the heat exchanger 44 is operable in a conventional manner to draw heat away from fuel passing therethrough. In some embodiments, the heat exchanger 44 may be positioned in a different location along the fuel line 36, 40 and/or 42, and in other embodiments the heat exchanger 44 may be omitted altogether.

In addition to the valves 18 and 38, the control system 10 illustrated in FIG. 1 further includes an electronic control unit (ECU) 50 operable to control the valves 18, 38 as will be described in detail hereinafter. The ECU is conventional and illustratively includes a conventional processor (or multiple processors) 52 electrically connected to a conventional memory 54, wherein the memory 54 illustratively has instructions stored therein which, when executed by the processor 52, causes the processor to control the valves 18, 38 in the manner to be described below. In this regard, a VCV output of the ECU 50 is electrically connected to a control input of the volume control valve (VCV) 18 via a signal path 56, and a PCV output of the ECU 50 is electrically connected to a control input of the pressure control valve (PCV) 38 via a signal path 58. In one embodiment, the VCV 18 and the PCV 38 are each controlled by supplying pulse-width modulated, constant frequency control signals to the control inputs thereof, wherein the duty cycles of such control signals determine the orifice size, e.g., cross-sectional opening area, of the fuel outlets thereof. Those skilled in the art will recognize other conventional control techniques for varying the orifice sizes of the VCV 18 and/or PCV 38, and it will be understood that any such other control techniques, and corresponding valve embodiments, are contemplated by this disclosure.

The control system 10 further includes a number of conventional sensors each configured and positioned to produce one or more signals corresponding to one or more operating parameters of the fuel injection system 11 and/or of an internal combustion engine (not shown) to which the fuel injection system 11 is operatively mounted or otherwise operatively coupled. As one example, the control system 10 illustratively includes a conventional pressure sensor (P) 60 fluidly coupled to the fuel rail 26 and electrically connected to a rail pressure input (RP) of the ECU 50 via a signal path 62. The pressure sensor 60 is illustratively operable to produce one or more signals corresponding to the pressure, i.e., fuel pressure, within the fuel rail 26. As another example, the control system 10 illustratively includes an engine rotational speed sensor (ERS) 64 operatively coupled to the internal combustion engine to which the fuel system 11 is operatively coupled, and electrically connected to an engine speed input (ES) of the ECU 50 via a signal path 66. The engine rotational speed sensor 64 is illustratively operable to produce one or more signals corresponding to the rotational speed (and, in some embodiments also the position relative to a reference position) of the crankshaft of the engine.

The control system 10 further illustratively includes N additional sensors 68, where N may be any positive integer, each electrically connected to one of a corresponding number of sensor data inputs (SDI) of the ECU 50 via one of a corresponding number of signal paths 70₁-70_{N}, and each configured to produce one or more signals corresponding to an operating parameter associated with operation of the fuel injector system 11, operation of an internal combustion engine to which the fuel injector system 11 is operatively coupled and/or operation of a stationary or movable vehicle carrying the internal combustion engine. Examples of sensors included in the additional sensors 68 may include, but are not limited to, a vehicle speed sensor, a barometric pressure sensor, an ambient temperature sensor, a cylinder pressure sensor, a cylinder temperature sensor, an exhaust gas temperature sensor, an engine temperature sensor, an engine oil pressure sensor, a key switch, an accelerator pedal sensor, a cruise control set/resume/off position sensor, a boost pressure sensor, an air intake flow sensor, an exhaust gas recirculation (EGR) flow sensor, and the like.

Operation of the control system 10 is controlled by actuation and control of the volume control valve (VCV) 18, alternatively known in the art as a fuel metering valve, and the pressure control valve 38 via the ECU 50 based on sensor data received from the pressure sensor 60 and from others of the sensors 64 as well as from commands generated by the ECU based on such sensor data. In the illustrated embodiment, the low pressure fuel pump 12 draws fuel from the fuel supply 14, and pumps the fuel through a fuel filter 16 to the fuel inlet of the high pressure fuel pump 20. In one embodiment, the low and high pressure fuel pumps 12, 20 are illustratively powered from the engine crankshaft, although in alternate embodiments either or both of the pumps 12, 20 can be powered via an alternate power source such as an electrical or electromechanical power source. At the fuel inlet of the high pressure fuel pump 20, the VCV 18 is actuated and controlled by the ECU 50 to controllably regulate the amount of fuel entering the high pressure fuel pump 20. There mechanical pressure relief valve 24 relieves excess pressure that may build up back to the fuel source 14. Some of the fuel used to lubricate the pump 20, also exits the pump 20 via the fuel return line 46.

The pressurized fuel from the high pressure pump 20 is transported to the via the one or more high pressure fuel lines 28 to the fuel rail 26, and multiple high pressure fuel lines 32₁-32₄ fluidly couple the fuel rail 26 to each of the multiple fuel injectors 30₁-30₄. Fuel return lines 34₁-34₄ fluidly couple each of the fuel injectors 30₁-30₄ to the fuel supply 14 via a system of fuel return lines 36, 40 and, in some embodiments, a heat exchanger 44. At a fuel outlet of the fuel rail 26, the PCV 38 is actuated and controlled by the ECU 50 to controllably regulate the amount of fuel exiting the fuel rail 26 and returning to the fuel supply 14.

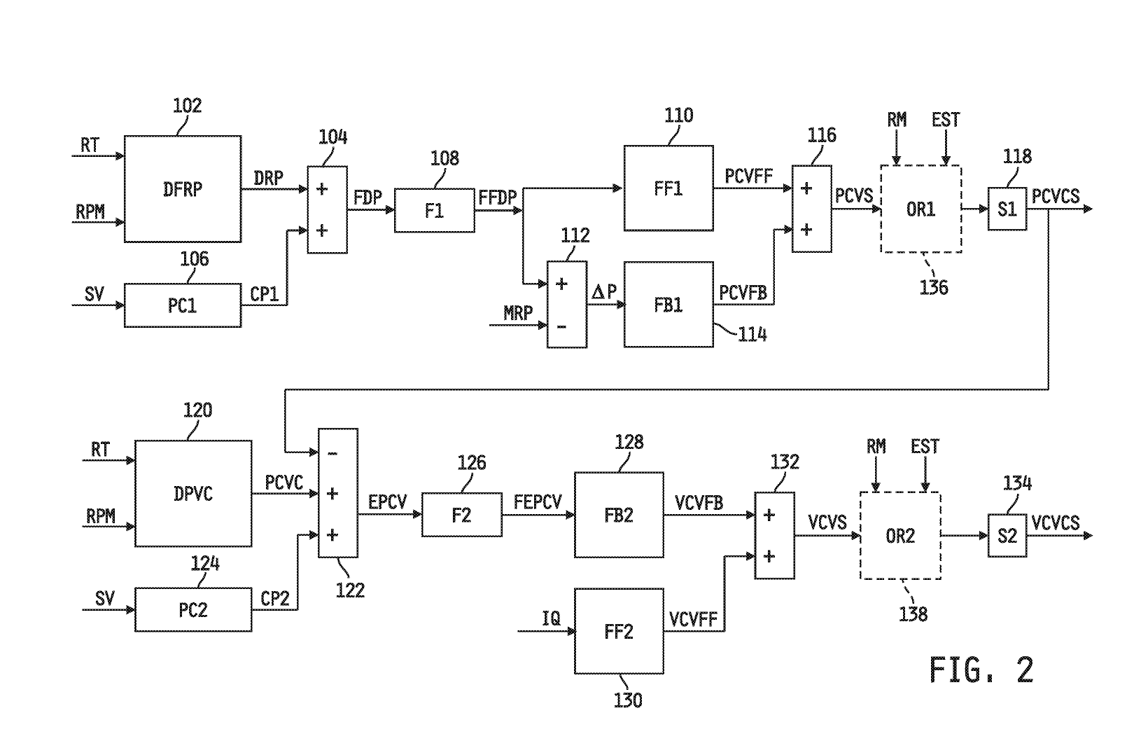

Referring now to FIG. 2, an embodiment is shown of a control structure 100 executed by the ECU 50 to control actuation and operation of the VCV 18 and the PCV 38. In one embodiment, the control structure 100 is stored in the memory 54 in the form of instructions which, when executed by the processor 52, cause the processor 52 to control actuation and operation of the VCV 18 and the PCV 38, e.g., by producing VCV control signals provided to the VCV 18 via the signal path 56 and by producing PCV control signals provided to the PCV 38 via the signal path 58. In other embodiments, the control structure 100 may be implemented in whole or in part in the form of hardware components, e.g., electrical circuit components, firmware components and/or software. In any case, the control structure 100 is illustrated in FIG. 2 in the form of logic blocks or modules and functional blocks or modules, and will be described below in this context. It will be understood that one or more of the logic and/or functional blocks or modules may be combined to form a larger logic and/or functional blocks or modules, and vice versa, and in this regard the logic and functional blocks or modules illustrated by example in FIG. 2 should not be considered to be limiting.

In the illustrated embodiment, the control structure 100 includes a Desired Fuel Rail Pressure (DFRP) block 102 which receives as inputs a Requested Torque (RT) value and an engine speed value, RPM, determined by the processor 52 based on the engine speed signal, ES, produced by the engine rotational speed sensor (ERS) 64. In the illustrated embodiment, the Requested Torque value RT is illustratively determined by the processor 52 in a conventional manner as a function of RPM and accelerator pedal position (or cruise control set speed), although this disclosure contemplates other embodiments in which RT is produced by the processor 52 based on more, fewer or different operating signals. In any case, the DFRP block 102 is illustratively operable, in a conventional manner, to process RT and RPM to determine therefrom a pressure value corresponding to a desired fuel pressure within the fuel rail 26, and to produce as an output a corresponding desired rail pressure value (DRP).

The output of the DFRP block 102 is provided to one additive input of a summation block 104 having another additive input receiving the output of a Pressure Correction (PC1) block 106 receiving as input(s) one or more sensor value(s) (SV) corresponding to the signals produced by one or more of the sensors 68. The PC1 block 106 is illustratively operable, in a conventional manner, to process SV to determine therefrom a pressure correction value, CP1, based on the one or more sensor values SV. The output of the summation block 104 is the sum of DRP and CP1 and is a final desired fuel rail pressure value, FDP. Those skilled in the art will recognize other sensor values that may be used alternatively to or in addition to those just described to produce CP1, and it will be understood that any such other sensor values are contemplated by this disclosure.

In the illustrated embodiment, the control strategy 100 includes a filter (F1) block 108 that receives FDP as an input and produces a filtered final desired pressure value, FFDP, as an output. In one embodiment, the filter block 108 is implemented in the form of a preconditioning filter, e.g., a pre-filter, that is or includes a conventional rate limiter function configured to regulate the rate of change of FDP to ensure smooth operation of the illustrated control strategy. In some alternate embodiments, the filter block 108 may alternatively or additionally include one or more additional or different conventional filtering functions, and it will be understood that any such filter function(s) is/are contemplated by this disclosure. In other alternate embodiments, the filter block 108 may be omitted.

In the illustrated embodiment, FFDP is provided as an input to a first feed forward (FF1) block 110 and to an additive input of another summation block 112. The FF1 block 110 is illustratively operable, as will be described below, to produce as an output a switching signal, e.g., in the form of a pulse-width modulated (PWM), constant frequency signal, PCVFF, having a duty cycle determined, in part, by FFDP. A subtractive input of the summation block 112 receives a measured rail pressure value, MRP, determined by the processor 52 based on the pressure signal, RP, produced by the fuel rail pressure sensor (P) 60. The output of the summation block 112 is a difference pressure value, ΔP, corresponding to the difference between of FFDP and MRP, and ΔP is provided as an input to a conventional feedback controller (FB1) block 114. In one embodiment, the controller FB1 is a conventional gain-scheduled proportional-integral-derivative (PID) controller, although in alternate embodiments FB1 may be or include a conventional proportional-integral (PI) controller or other conventional controller. In any case, the F131 controller 114 is illustratively operable in a conventional manner to process the pressure difference value ΔP to produce a switching signal, e.g., in the form of a pulse-width modulated (PWM), constant frequency signal, PCVFB having a duty cycle determined by ΔP.

The output signal PCVFF of the FF1 block 110 is provided to one additive input of another summation block 116, and the output signal PCVFB of the FB1 controller block 114 is provided to another additive input of the summation block 116. The output PCVS of the summation block 116 is the sum of PCVFF and PCVFB and is a pulse-width modulated (PWM), constant frequency signal that is illustratively provided to an input of a Saturation (S1) block 118. The output of the Saturation block 118 is the PCV actuation and control signal PCVCS provided by the ECU 50 to the input of the pressure control valve (PCV) via the signal path 58. In the illustrated embodiment, the Saturation block 118 is operable in a conventional manner to limit the magnitudes of PCVCS to values between 0 and 1. The PCV 38 is illustratively configured to be responsive to the control signal PCVCS to establish a fuel outlet orifice or opening size through which fuel in the fuel rail 26 may pass to the fuel supply 14 via the fuel return lines 40, 42.

In one embodiment, the feedforward block FF1 110 is illustratively implemented in the form of a lookup table or other suitable mapping structure that maps desired rail pressure values FFDP to PCVFF values in order to establish corresponding PCV orifice sizes or opening levels. Illustratively, the PCVFF values are correlated with values of temperature of fuel exiting the fuel outlet of the PCV 38 such that operation of the PCV 38 in response to a combination of the feedback PCV control signal and any of the PCVFF values results in a fuel outlet orifice size of the PCV 38 which maintains the temperature of fuel exiting the fuel outlet of the PCV 38 within a specified temperature range or limits the temperature of fuel exiting the fuel outlet of the PCV 38 to a specified maximum temperature. In the illustrated embodiment, such PCVFF values populating the lookup table are determined experimentally as a function of fuel temperature to ensure that the temperature of fuel exiting fuel outlet the PCV 38 to the rail fuel return line 40 does not exceed the specified temperature, and/or remains within the specified temperature range, over an entire operating range (or specified operating sub-range) of the internal combustion engine to which the fuel injection system 11 is operatively coupled. In one embodiment, the PCVFF values populating the lookup table are illustratively duty cycle values which, when combined with the PCVFB values, result in PCVCS having a duty cycle to which the PCV 38 will be responsive at the control input thereof to establish corresponding PCV orifice sizes that limit the temperature of fuel passing therethrough to the maximum fuel temperature, or that maintain the fuel temperature within the specified temperature range, over a specified operating range of the engine.

In the illustrated embodiment, the control structure 100 further includes a Desired PCV command (DPCV) block 120 which receives as inputs the Requested Torque value, RT, and the engine speed value, RPM. The DPCV block 120 is illustratively operable to process RT and RPM to determine therefrom a desired PCV command value that, if provided to the control input of the PCV 38, would result in a desired PCV orifice size or opening level, e.g., based on a desired fuel pressure within the fuel rail 26 also determined as a function of RT and RPM as described above with respect to the DFRP block 102, and to produce as an output a corresponding desired PCV command value (PCVC).

The output of the DPCV block 120 is provided to one additive input of another summation block 122 having another additive input receiving the output of another Pressure Correction (PC2) block 124 receiving as input(s) one or more sensor value(s) (SV) corresponding to the signals produced by one or more of the sensors 68. The PC2 block 124 is illustratively operable, in a conventional manner, to process SV to determine therefrom a pressure correction value, CP2, based on the one or more sensor values SV. Those skilled in the art will recognize other sensor values that may be used alternatively to or in addition to those just described to produce CP2, and it will be understood that any such other sensor values are contemplated by this disclosure. In any case, the summation block 122 also has a subtractive input receiving the PCV control signal PCVCS produced by the Saturation block 118 as described above. The output of the summation block 122 is thus the value (PCVC+CP2)−PCVCS and is a PCV command error value, EPVC, determined as the difference between the corrected, desired PCV command (PCVC+CP2) and the actual PCV command PCVCS provided to the PCV 38.

In the illustrated embodiment, the control structure 100 includes another filter (F2) block 126 that receives EPVC as an input and produces a filtered PCV command error value, FEPVC, as an output. In one embodiment, the filter block 126 is implemented in the form of a preconditioning filter, e.g., a pre-filter, that is or includes a conventional rate limiter function configured to regulate the rate of change of EPCV to ensure smooth operation of the illustrated control strategy. In some alternate embodiments, the filter block 126 may alternatively or additionally include one or more additional or different conventional filtering functions, and it will be understood that any such filter function(s) is/are contemplated by this disclosure. In other alternate embodiments, the filter block 126 may be omitted.

FEPVC is provided as an input to a second feedback (FB2) controller block 128. In one embodiment, the controller FB2 is a conventional gain-scheduled proportional-integral-derivative (PID) controller, although in alternate embodiments FB2 may be or include a conventional proportional-integral (PI) controller or other conventional controller. In any case, the FB2 controller 126 is illustratively operable in a conventional manner to process the PCV command error value FEPVC to produce a switching signal, e.g., in the form of a pulse-width modulated (PWM), constant frequency signal, VCVFB having a duty cycle determined by FEPVC.

In the illustrated embodiment, the control structure 100 illustratively includes a second feedforward (FF2) block 130 which is operable, as will be described in detail below, to produce as an output a switching signal, e.g., in the form of a pulse-width modulated (PWM), constant frequency signal, VCVFF, having a duty cycle determined by an injection quantity (IQ) input value. VCVFB and VCVFF are each provided to additive inputs of yet another summation block 132, and the output of the summation block 132 is the sum of VCVFB and VCVFF.

The output signal VCVFB of the FB2 controller block 128 is provided to one additive input of yet another summation block 132, and the output signal VCVFF of the FB2 block 130 is provided to another additive input of the summation block 132. The output VCVS of the summation block 132 is the sum of VCVFB and VCVFB and is a pulse-width modulated (PWM), constant frequency signal that is illustratively provided to an input of another Saturation (S2) block 134. The output of the Saturation block 134 is the VCV actuation and control signal VCVCS provided by the ECU 50 to the input of the volume control valve (VCV) via the signal path 56. In the illustrated embodiment, the Saturation block 134 is operable in a conventional manner to limit the magnitude of VCVCS to values between 0 and 1. The VCV 18 is illustratively configured to be responsive to the control signal VCVCS to establish a fuel outlet orifice or opening size through which fuel provided by the low pressure fuel pump 12 may pass to the high pressure fuel pump 20 for pumping by the high pressure fuel pump 20 to the fuel rail 26.

In one embodiment, the feedforward block FF2 130 is illustratively implemented in the form of a lookup table or other suitable mapping structure that maps injected fuel quantity (IQ) to VCFF values in order to establish corresponding VCV orifice sizes or opening levels that will provide for the supply of fuel to the fuel rail 26 based on fuel drawn out of the fuel rail 26 via actuation of the fuel injectors 30₁-30₄. In the illustrated embodiment, the injected fuel quantity value IQ is illustratively determined by the processor 52 in a conventional manner, e.g., as a function of RT and RPM, although this disclosure contemplates other embodiments in which IQ is produced by the processor 52 based on more, fewer or different operating signals. In one embodiment, the VCVFF values populating the lookup table are illustratively duty cycle values which, when combined with the VCVFF values, result in VCVCS having a duty cycle to which the VCV 18 will be responsive at the control input thereof to establish corresponding VCV orifice sizes that provide for passage to the high pressure fuel pump 20 sufficient amounts of fuel to maintain a desired fuel pressure within the fuel rail 26 over all or a specified operating range of the engine.

Generally, high pressure ratios across the PCV 38 result in increased temperatures at the outlet of the PCV 38 due to valve contraction effects, and this effect becomes amplified as the flow of fuel through the PCV 38 increases. Accordingly, it is desirable to control the amount of fuel entering the fuel rail 26 so as to control both the pressure ratio across the PCV 38 and the amount of fuel flow therethrough. This is illustratively accomplished in the control structure 100 via control of the VCV 18 based on the error between the desired opening level for the PCV 38 and the actual opening level for the PCV 38. This control strategy illustratively maintains an optimal fuel pressure within the fuel rail 26 while also minimizing both the amount of fuel in the fuel return lines 36, 40, 42 and the temperature of fuel in the fuel return lines 40, 42.

In some embodiments, it may not be desirable to control VCV 18 and/or PCV 38 as just described over all operating conditions of the engine, and in such embodiments one or more override blocks may be inserted into the control structure 100. In the embodiment illustrated in FIG. 2, for example, an override block (OR1) 136 may optionally be inserted between the summation block 116 and the Saturation block 118 as illustrated by dashed-line representation. Alternatively or additionally, an override block (OR2) 138 may be optionally inserted between the summation block 132 and the Saturation block 134 as illustrated by dashed-line representation in FIG. 2. In either case, the override block 136, 138 receives as inputs an engine running mode value, RM, and, in some embodiments, an emergency stop signal (EST).

The running mode value, RM, is illustratively a value indicative of the operating state of the internal combustion engine to which the fuel injection system 11 is operatively coupled, and by way of example the running mode value may be one of engine stopped, engine running, engine cranking, or engine shutting down. The running mode value is illustratively determined by the ECU as a function of one or more signals produced by one or more of the sensors 64, 68, e.g., the engine rotational speed sensor 56, the key switch, the accelerator pedal position sensor, etc. In some embodiments, the emergency stop signal, EST, is likewise produced by the ECU as a function of one or more signals produced by one or more of the sensors 64, 68, although in alternate embodiments EST may be alternatively or additionally produced via manual actuation of a button or lever.

In any case, in embodiments that include either or both of the override blocks 136, 138, each is operable to pass the respective PCVS or VCVS value to the corresponding Saturation block 118 or 134 under certain operating conditions, e.g., RM=engine running or engine cranking and EST=OFF, and to override operation of the control structure 100 by blocking passage of PCVS or VCVS respectively under other operating conditions, e.g., RM=engine stopped or engine shutting down or EST=ON. When operating in override, the override block 136 may illustratively control PCVS with a default signal to a default state, e.g., ON or OFF, and the override block 138 may likewise illustratively control VCVS to a default state, e.g., ON or OFF. In alternate embodiments, the override block 136 may be operable in override to control PCVS to a default state corresponding to an intermediate static value or a dynamic value e.g. the output of either FF1 or FB1, and/or the override block 138 may be operable in override to control VCVS to an intermediate static value or a dynamic value, e.g., the output of either FF2 or FB2. Those skilled in the art will recognize other override control strategies in which the override block 136 may be operable to control PCVS to an alternate default state and/or the override block 138 may be operable to control VCVS to an alternate default state, and it will be understood that any such other override control strategies are contemplated by this disclosure.

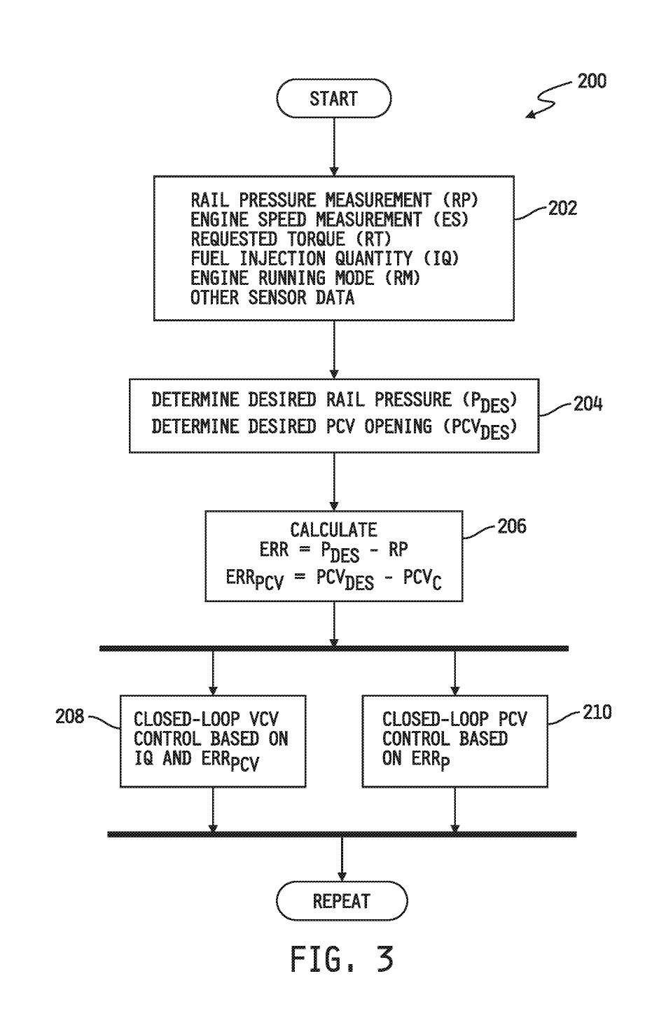

Referring now to FIG. 3, a flowchart is shown of an embodiment of a process 200 for controlling PCV 38 and VCV 18 as just described with respect to the control structure of FIG. 2. In one embodiment, the control process 200 is illustratively stored in the memory 54 in the form of instructions which, when executed by the processor 52, cause the processor 52 to control PCV 38 and VCV 18 as described. Alternatively or additionally, one or more aspects of the process 200 may be implemented in the form of one or more hardware components, e.g., electrical circuit components, firmware or software. In any case, it will be understood that the illustrated steps of the process 200 need not be carried out by the control structure 100 illustrated in FIG. 2 and may instead by carried out in accordance with one or more alternative control structures.

The process 200 illustratively begins at step 202, where the ECU 50 receives engine speed input, ES, rail pressure input, RP and other sensor inputs from one or more of the sensors 68, and determines the running mode (RM) of the engine as described above, the requested torque, RT and the fuel injection quantity, IQ. Based on the engine running mode, RM, the engine speed, ES, the requested torque, RT, and the injection quantity, IQ, the ECU 50 determines at step 204 a desired rail pressure value, P_{DES} and a desired opening level or orifice size PVC_{DES} for the PCV 38. In one embodiment, the desired opening level PVC_{DES} for the PCV 38 is illustratively determined from an empirical map that ensures an acceptable fuel temperature in the fuel rail return line 40.

At step 206, the rail pressure signal, RP, is used to find the error, ERR_{P} between the desired rail pressure, P_{DES} and the actual rail pressure RP, i.e., ERR_{P}=P_{DES}−RP. Based on the pressure error, ERR_{P}, the PCV is commanded (PVC_{C}) at step 208 so as to compensate for the error, i.e., in a manner that minimizes the error by driving the error to or toward zero. Also at step 206, the error, ERR_{PVC}, between the desired PCV opening level PVC_{DES} and the commanded PCV opening level, PVC_{C}, is determined by the ECU 50. Based on the error ERR_{PVC}, the VCV is commanded (VCV_{C}) at step 210, although with a slower time constant than used at step 208, so as to compensate for the error, i.e., in a manner that minimizes the error by driving the error to or toward zero. In this manner, the PCV 38 is always commanded to regulate pressure fluctuations while the VCV 18 is commanded so to ensure that the orifice size of the PCV 38 is regulated to a predetermined desired value.

The desired opening level, PCV_{DES} is illustratively determined experimentally to ensure that the temperature in the fuel return line 40 leaving the PCV 38 remains within an acceptable range, or is limited to a maximum temperature value, over the entire engine operating range. The process also controls the amount of fuel entering the fuel rail 26 by controlling the VCV 18 as a function of the difference between PCV_{DES} and the commanded PCV value, PCV_{C}, so as to maintain the temperature in the fuel return line 40 within the acceptable range or limited to a maximum temperature value.

### Alternate Embodiments

In one alternate embodiment of the control system 10 illustrated in FIG. 1, a temperature sensor (T) 72 may be positioned in communication with the rail fuel return line 40, e.g., at the outlet of the PCV 38, and electrically connected to a Fuel Temperature (FT) input of the ECU 50 via a signal path 74 as illustrated in dashed-line representation in FIG. 1. In this alternate embodiment, the temperature sensor 72 is illustratively configured to produce a temperature signal (TS) on the signal path 74 corresponding to the temperature of fuel within the rail fuel return line 40 and/or corresponding to the temperature of the fuel outlet of the PCV 38. In a corresponding alternate embodiment of the control structure 100 illustrated in FIG. 2, the PCV 38 can be controlled as described above, with or without FF1 including temperature compensation. Additionally, the block 120 can be replaced in this embodiment with a desired fuel temperature block, which can be configured, e.g., as described above with respect to the FF1 block 110, to determine desired PCV 38 outlet temperature (T_{DES}) values under various fuel rail pressures, RP, and block 124 can be used to correct the T_{DES} values. Instead of the PCVCS signal applied to the subtractive input of the summation block 122 as illustrated in FIG. 2, the measured temperature signal, TS, provided to the subtractive input of the summation block 122 such that the error value, ERR, produced at the output of the summation block 122 is ERR=(T_{DES}+PC2)−TS.

In another alternate embodiment, the fuel injection system 11 illustrated in FIG. 1 may have no PCV 38 or fuel rail return line 40. In this embodiment, the VCV 18 is the sole actuator of the system, and the measure rail pressure signal, RP, may be used in this embodiment for closed-loop control the VCV 18. For example, in this embodiment, the desired rail pressure can be determined, corrected and filtered as described above with reference to FIG. 2 to yield a final reference pressure value or signal. This reference pressure value or signal may then serve as an input for a conventional feed forward controller, and will also be subtracted from RP to yield an error signal fed to a feedback controller. The output of the feed forward and feedback controllers may then be added together, possibly overridden by pre-specified values due to the engine running mode and emergency stop signals, and possibly saturated and sent as a command or control signal to control the VCV 18.

In still another embodiment, the fuel injection system 11 illustrated in FIG. 1 may have no VCV 18. In this embodiment, the PCV 38 is the sole actuator in the system, and control of the PCV 38 in such a system may be as described above for regulating the fuel rail pressure. In such a system, additional passive control may be desirable to maintain the temperature at the outlet of the PCV 38 in an acceptable range, such as by designing or using existing fuel pumps with limited pumping capacity, implementing one or more regulated pressure relief valves, and/or by implementing one or more fuel heat exchangers in one or more of the fuel return lines 34₁-34₄, 36, 40 and/or 42.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

What is claimed is:

1. A system for controlling fuel rail pressure, comprising:
a fuel rail,
a fuel pump to supply pressurized fuel from a source of fuel to the fuel rail,
a pressure sensor to produce a rail pressure signal corresponding to fuel pressure within the fuel rail,
a plurality of additional sensors each producing a signal corresponding to a different operating parameter of an internal combustion engine to which the fuel rail and the fuel pump are operatively coupled,
a pressure control valve having a fuel inlet fluidly coupled to the fuel rail, a fuel outlet and a control input responsive to a PCV control signal to establish a corresponding orifice size at the fuel outlet thereof,
a processor, and
a memory having instructions stored therein which, when executed by the processor, cause the processor to determine a desired rail pressure value based on signals produced by one or more of the plurality of additional sensors, to determine a feedback PCV control signal based on a difference between the desired rail pressure value and the rail pressure signal, to determine a feedforward PCV control signal based on the desired rail pressure, and to produce the PCV control signal based on a sum of the feedback PCV control signal and the feedforward PCV control signal,
wherein the feedforward PCV control signal is correlated with temperature of fuel exiting the fuel outlet of the pressure control valve such that operation of the pressure control valve in response to the PCV control signal results in fuel outlet orifice sizes which one of maintains the temperature of fuel exiting the fuel outlet of the pressure control valve within a specified temperature range and limits the temperature of fuel exiting the fuel outlet to a specified maximum temperature.

2. The system of claim 1, further comprising a volume control valve having a fuel inlet to receive fuel from the source of fuel, a fuel outlet fluidly coupled to a fuel inlet of the fuel pump and a control input responsive to a VCV control signal to establish a corresponding orifice size at the fuel outlet thereof,
and wherein the instructions stored in the memory further include instructions which, when executed by the processor, cause the processor to determine a desired pressure control valve control value and an injected fuel quantity based on signals produced by one or more of the plurality of additional sensors, to determine a feedforward VCV control signal based on the injected fuel quantity, to determine a feedback VCV control signal based on a difference between the desired pressure control valve control value and the PCV control signal and to produce the VCV control signal based on a sum of the feedforward VCV control signal and the feedback VCV control signal.

3. The system of claim 1, further comprising:
a volume control valve having a fuel inlet to receive fuel from the source of fuel, a fuel outlet fluidly coupled to a fuel inlet of the fuel pump and a control input responsive to a VCV control signal to establish a corresponding orifice size at the fuel outlet thereof, and
a temperature sensor to produce a temperature signal corresponding to temperature of fuel exiting the pressure control valve,
and wherein the instructions stored in the memory further includes instructions which, when executed by the processor, cause the processor to determine a desired pressure control valve outlet temperature value and an injected fuel quantity based on signals produced by one or more of the plurality of additional sensors, to determine a feedforward VCV control signal based on the injected fuel quantity, to determine a feedback VCV control signal based on a difference between the desired pressure control valve outlet temperature value and the temperature signal and to produce the VCV control signal based on a sum of the feedforward VCV control signal and the feedback VCV control signal.

4. The system of claim 1, wherein the memory further has a map stored therein populated with PCV feedforward control signal values mapped to corresponding desired rail pressure values, the processor determining the PCV feedforward control signals by mapping desired rail pressure values to corresponding ones of the PCV feedforward control signal values using the map,
and wherein the PCV feedforward control signal values populating the map are correlated with experimental values of pressure control valve fuel outlet temperatures vs pressure control valve outlet orifice sizes.

5. The system of claim 1, wherein the instructions stored in the memory further include instructions which, when executed by the processor, cause the processor to determine a corrected pressure value based on signals produced by one or more of the plurality of additional sensors, and to determine the desired rail pressure value further based on the corrected pressure value.

6. The system of claim 1, wherein the instructions stored in the memory further include instructions which, when executed by the processor, cause the processor to rate limit the desired rail pressure value prior to determining the feedback PCV control signal and the feedforward PCV control signal.

7. The system of claim 1, wherein the instructions stored in the memory further include instructions which, when executed by the processor, cause the processor to determine an engine running mode value based on signals produced by one or more of the plurality of additional sensors, and to override the pressure control valve control signal with a default control signal if the engine running mode value corresponds to one or more predetermined engine running mode values.

8. A system for controlling fuel rail pressure, comprising:
a fuel rail,
a fuel pump to supply pressurized fuel from a source of fuel to the fuel rail,
a pressure sensor to produce a rail pressure signal corresponding to fuel pressure within the fuel rail,
a plurality of additional sensors each producing a signal corresponding to a different operating parameter of an internal combustion engine to which the fuel rail and the fuel pump are operatively coupled,
a pressure control valve having a fuel inlet fluidly coupled to the fuel rail, a fuel outlet and a control input responsive to a PCV control signal to establish a corresponding orifice size at the fuel outlet thereof,
at least a first logic module to determine a desired rail pressure value based on signals produced by one or more of the plurality of additional sensors,
a first feedback controller to determine a feedback PCV control signal based on a difference between the desired rail pressure value and the rail pressure signal,
a first feedforward module including a map populated with feedforward PCV control values mapped to corresponding desired rail pressure values, the first feedforward module to determine a feedforward PCV signal by mapping desired rail pressure values to corresponding feedforward PCV control values using the map, and
at least a second logic module to produce the PCV control signal based on a sum of the feedback PCV control signal and the feedforward PCV control signal,
wherein the feedforward control values populating the map are correlated with temperature of fuel exiting the fuel outlet of the pressure control valve such that operation of the pressure control valve in response to the PCV control signal results in fuel outlet orifice sizes which one of maintains the temperature of fuel exiting the fuel outlet of the pressure control valve within a specified temperature range and limits the temperature of fuel exiting the fuel outlet to a specified maximum temperature.

9. The system of claim 8, further comprising:
a volume control valve having a fuel inlet to receive fuel from the source of fuel, a fuel outlet fluidly coupled to a fuel inlet of the fuel pump and a control input responsive to a VCV control signal to establish a corresponding orifice size at the fuel outlet thereof,
at least a third logic module to determine a desired pressure control valve control value based on signals produced by one or more of the plurality of additional sensors and to determine an error value as a difference between the desired pressure valve control value and the PCV control signal,
a second feedback controller to determine a feedback VCV control signal based on the error value,
a second feedforward module to map injected fuel quantity values to corresponding feedforward VCV signal values, and
at least a fourth logic module to produce the VCV control signal based on a sum of the feedback VCV control signal and the feedforward VCV control signal values.

10. The system of claim 8, further comprising:
a volume control valve having a fuel inlet to receive fuel from the source of fuel, a fuel outlet fluidly coupled to a fuel inlet of the fuel pump and a control input responsive to a VCV control signal to establish a corresponding orifice size at the fuel outlet thereof,
a temperature sensor to produce a temperature signal corresponding to temperature of fuel exiting the pressure control valve,
at least a third logic module to determine a desired pressure control valve outlet temperature value based on signals produced by one or more of the plurality of additional sensors and to determine an error value as a difference between the desired pressure control valve outlet temperature value and the temperature signal,
a second feedback controller to determine a feedback VCV control signal based on the error value,
a second feedforward module to map injected fuel quantity values to corresponding feedforward VCV signal values, and
at least a fourth logic module to produce the VCV control signal based on a sum of the feedback VCV control signal and the feedforward VCV control signal values.

11. The system of claim 8, wherein the PCV feedforward control values populating the map are correlated with experimental values of pressure control valve fuel outlet temperatures vs pressure control valve outlet orifice sizes.

12. The system of claim 8, wherein the at least a first logic module includes logic determine a corrected pressure value based on signals produced by one or more of the plurality of additional sensors, and to determine the desired rail pressure value further based on the corrected pressure value.

13. The system of claim 8, further comprising a rate limiter to rate limit the desired rail pressure value prior to determining the feedback PCV control signal and the feedforward PCV control signal values.

14. The system of claim 8, further comprising at least a third logic module to determine an engine running mode value based on signals produced by one or more of the plurality of additional sensors, and to override the pressure control valve control signal with a default control signal if the engine running mode value corresponds to one or more predetermined engine running mode values.

15. A method for controlling fuel rail pressure in a common rail fuel injection system having a common rail, a fuel pump to supply pressurized fuel from a fuel source to the fuel rail, a pressure sensor to produce a rail pressure signal corresponding to fuel pressure within the fuel rail, a plurality of additional sensors each producing a signal corresponding to a different operating parameter of an internal combustion engine to which the fuel rail and the fuel pump are operatively coupled and a pressure control valve having a fuel inlet fluidly coupled to the fuel rail, a fuel outlet and a control input responsive to a PCV control signal to establish a corresponding orifice size at the fuel outlet thereof, the method comprising:
determining, with a processor, a desired rail pressure value based on signals produced by one or more of the plurality of additional sensors,
determining, with the processor, a feedback PCV control signal based on a difference between the desired rail pressure value and the rail pressure signal produced by the pressure sensor,
populating a map stored in a memory with pressure control valve control values mapped to corresponding desired rail pressure values, the pressure control valve control values correlated with values of temperature of fuel exiting the fuel outlet of the pressure control valve such that operation of the pressure control valve in response to a combination of the feedback PCV control signal and any of the pressure control valve control values results in a fuel outlet orifice size which one of maintains the temperature of fuel exiting the fuel outlet of the pressure control valve within a specified temperature range and limits the temperature of fuel exiting the fuel outlet to a specified maximum temperature,
determining, with the processor, a feedforward PCV signal by mapping the desired rail pressure value to a corresponding one of the pressure control valve control values populating the map,
producing, with the processor, the PCV control signal based on a sum of the feedback PCV control signal and the feedforward PCV control signal, and
controlling the pressure control valve by applying, via the processor, the PCV control signal to the control input of the pressure control valve.

16. The method of claim 15, wherein the common rail fuel injection system further includes a volume control valve having a fuel inlet to receive fuel from the source of fuel, a fuel outlet fluidly coupled to a fuel inlet of the fuel pump and a control input responsive to a VCV control signal to establish a corresponding orifice size at the fuel outlet thereof, and wherein the method further comprises:
determining, with the processor, a desired pressure control valve control value based on signals produced by one or more of the plurality of additional sensors,
determining, with the processor, a feedback PCV control signal based on a difference between the desired pressure control valve control value and the PCV control signal,
determining, with the processor, a feedforward VCV signal based on an injected fuel quantity value determined based on signals produced by one or more of the plurality of sensors,
producing, with the processor, the VCV control signal based on a sum of the feedback CCV control signal and the feedforward CCV control signal, and
controlling the volume control valve by applying, via the processor, the VCV control signal to the control input of the volume control valve.

17. The method of claim 15, wherein the common rail fuel injection system further includes a volume control valve having a fuel inlet to receive fuel from the source of fuel, a fuel outlet fluidly coupled to a fuel inlet of the fuel pump and a control input responsive to a VCV control signal to establish a corresponding orifice size at the fuel outlet thereof, and a temperature sensor to produce a temperature signal corresponding to temperature of fuel exiting the pressure control valve, wherein the method further comprises:
determining, with the processor, a desired pressure control valve outlet temperature based on signals produced by one or more of the plurality of additional sensors,
determining, with the processor, a feedback VCV control signal based on a difference between the desired pressure control valve outlet temperature and the temperature signal,
determining, with the processor, a feedforward VCV signal based on an injected fuel quantity value determined based on signals produced by one or more of the plurality of sensors,
producing, with the processor, the VCV control signal based on a sum of the feedback CCV control signal and the feedforward CCV control signal, and
controlling the volume control valve by applying, via the processor, the VCV control signal to the control input of the volume control valve.

18. The method of claim 15 further comprising:
determining, with the processor, a corrected pressure value based on signals produced by one or more of the plurality of additional sensors, and
determining, with the processor, the desired rail pressure value further based on the corrected pressure value.

19. The method of claim 15 further comprising rate limiting the desired rail pressure value prior to determining the feedback PCV control signal and the feedforward PCV control signal.

20. The method of claim 5, further comprising:
determining, with the processor, an engine running mode value based on signals produced by one or more of the plurality of additional sensors, and
overriding, with the processor, the pressure control valve control signal with a default control signal if the engine running mode value corresponds to one or more predetermined engine running mode values.

21. A system for controlling fuel rail pressure, comprising:
a fuel rail,
a fuel pump to supply pressurized fuel from a source of fuel to the fuel rail,
a pressure sensor to produce a rail pressure signal corresponding to fuel pressure within the fuel rail,
a plurality of additional sensors each producing a signal corresponding to a different operating parameter of an internal combustion engine to which the fuel rail and the fuel pump are operatively coupled,
a pressure control valve having a fuel inlet fluidly coupled to the fuel rail, a fuel outlet and a control input responsive to a PCV control signal to establish a corresponding orifice size at the fuel outlet thereof,
a volume control valve having a fuel inlet to receive fuel from the source of fuel, a fuel outlet fluidly coupled to a fuel inlet of the fuel pump and a control input responsive to a VCV control signal to establish a corresponding orifice size at the fuel outlet thereof,
a processor, and
a memory having instructions stored therein which, when executed by the processor, cause the processor to determine a desired rail pressure value based on signals produced by one or more of the plurality of additional sensors, to determine a feedback PCV control signal based on a difference between the desired rail pressure value and the rail pressure signal, to determine a feedforward PCV control signal based on the desired rail pressure, to produce the PCV control signal based on a sum of the feedback PCV control signal and the feedforward PCV control signal, to determine a desired pressure control valve control value and an injected fuel quantity based on signals produced by one or more of the plurality of additional sensors, to determine a feedforward VCV control signal based on the injected fuel quantity, to determine a feedback VCV control signal based on a difference between the desired pressure control valve control value and the PCV control signal and to produce the VCV control signal based on a sum of the feedforward VCV control signal and the feedback VCV control signal.

22. A method for controlling fuel rail pressure in a common rail fuel injection system having a common rail, a fuel pump to supply pressurized fuel from a fuel source to the fuel rail, a pressure sensor to produce a rail pressure signal corresponding to fuel pressure within the fuel rail, a plurality of additional sensors each producing a signal corresponding to a different operating parameter of an internal combustion engine to which the fuel rail and the fuel pump are operatively coupled, a pressure control valve having a fuel inlet fluidly coupled to the fuel rail, a fuel outlet and a control input responsive to a PCV control signal to establish a corresponding orifice size at the fuel outlet thereof and a volume control valve having a fuel inlet to receive fuel from the source of fuel, a fuel outlet fluidly coupled to a fuel inlet of the fuel pump and a control input responsive to a VCV control signal to establish a corresponding orifice size at the fuel outlet thereof, the method comprising:
determining, with a processor, a desired rail pressure value based on signals produced by one or more of the plurality of additional sensors,
determining, with the processor, a feedback PCV control signal based on a difference between the desired rail pressure value and the rail pressure signal produced by the pressure sensor,
determining, with the processor, a feedforward PCV signal based on the desired rail pressure value,
producing, with the processor, the PCV control signal based on a sum of the feedback PCV control signal and the feedforward PCV control signal,
controlling the pressure control valve by applying, via the processor, the PCV control signal to the control input of the pressure control valve,
determining, with the processor, a desired pressure control valve control value based on signals produced by one or more of the plurality of additional sensors,
determining, with the processor, a feedback PCV control signal based on a difference between the desired pressure control valve control value and the PCV control signal,
determining, with the processor, a feedforward VCV signal based on an injected fuel quantity value determined based on signals produced by one or more of the plurality of sensors, and
producing, with the processor, the VCV control signal based on a sum of the feedback CCV control signal and the feedforward CCV control signal, and controlling the volume control valve by applying, via the processor, the VCV control signal to the control input of the volume control valve.
